(19) United States
(12) Patent Application Publication
(10) Pub. No.: US 2025/0020827 A1
(43) Pub. Date: Jan. 16, 2025

(54) METHOD FOR PREDICTING LIGHTNING OUTAGE RATE OF HIGH-SPEED RAILWAY CONTACT SYSTEM BASED ON LIGHTNING LOCATION

(71) Applicant: Nanjing Joint Institute for Atmospheric Sciences, Nanjing (CN)

(72) Inventors: Yan LIU, Nanjing (CN); Zheng LI, Nanjing (CN); Wenhao HOU, Nanjing (CN); Xiao JING, Nanjing (CN); Yingkun FANG, Nanjing (CN); Shoujun CHEN, Nanjing (CN); Fengjiao CHEN, Nanjing (CN)

(21) Appl. No.: 18/631,055

(22) Filed: Apr. 10, 2024

(30) Foreign Application Priority Data
Jul. 14, 2023 (CN) 202310862189.4

(51) Int. Cl. G01W 1/10; B60L 13/00

(52) U.S. Cl. CPC G01W 1/10; B60L 13/00; B60L 2200/26

(57) ABSTRACT

Disclosed is a method for predicting a lightning outage rate of a high-speed railway contact system based on a lightning location, including the steps: (1) evaluating location errors of cloud-to-ground lightning flashes along a high-speed railway line; (2) evaluating a detection efficiency of the cloud-to-ground lightning flashes along the high-speed railway line; (3) calculating a ground flash density along the high-speed railway line; (4) fitting a cumulative probability function of the lightning current amplitudes along the high-speed railway line; and (5) constructing a calculation model for the lightning outage rate of the high-speed railway contact system.

### TECHNICAL FIELD

The present disclosure relates to the technical field of high-speed railway lightning outage, and in particular to a method for predicting a lightning outage rate of a high-speed railway contact system based on a lightning location.

### BACKGROUND

Since a high-speed railway is always located in open areas with few tall buildings on both sides, and often adopts viaduct laying method to make a height of a traction power supply contact system to the ground increased obviously, approaching to or even exceeding 110 kV power transmission lines, but an insulation level of a high-speed railway contact system is relatively low, making it extremely vulnerable to lightning strikes. According to statistics, there have been numerous cases of serious train delay and disruptions caused by failures in the traction network caused by lightning strikes after high-speed railway lines were put into operation. The tripping of the contact system due to lightning strikes has become a major risk affecting safe operation of high-speed railways. An effective approach to systematically solve the problem of lighting strike on the contact system is to elaborately evaluate lightning flashover characteristics of the contact system along the high-speed railway, adopt a targeted lightning protection scheme according to the severity of a contact system lightning outage rate, and implement differential protection of direct lightning and induction lightning measures upon the principle of technical economy optimization.

A ground flash density and a cumulative probability distribution function of lightning current amplitudes are two important parameters affecting the lightning outage rate. (1) A ground flash density value along the high-speed railway directly influences the number of times of lightning strikes on the high-speed railway contact system each year. Due to limitations of the technical level, the ground flash density in the engineering field is mostly derived from data of thunderstorm days, but the observation of the thunderstorm days depends on subjective identification of people, a radius of a human audiovisual range is about 8-15 km, making it difficult to multi-directional and full-angle observation, moreover, it is unable to distinguish intra-cloud discharge from cloud-to-ground lightning flash through observation on the thunderstorm days, while ground flash discharge is a risk source of outage of the contact system. The Guide for Technology of Lightning Protection for Traction Power Supply System of High-speed Railway (TB/T3551-2019) recommends that the ground flash density should be preferentially calculated by adopting the information obtained from the ground flash monitoring system, but fails to give detailed calculation method. A high-speed railway corridor is in linear distribution, featuring long distance and large geographical span, a lightning locator can realize large-scale ground flash detection by networking, however at the same time, the detection precision and the location error of the lightning locator by networking are susceptible to the station network layout, hardware characteristics, installation environment and topographic factors of the coverage area, and deviate from the parameters provided by its manufacturer, therefore, a ground flash density value determined according to the result evaluated through the real detection efficiency and the location error of the lightning location network along the high-speed railway is more accurate. (2) For a long time, the cumulative probability function of the lightning current amplitudes mostly adopts a formula recommended by IEEE or a lightning current amplitude cumulative probability formula (GB 50064-2014) of a lightning transmission line pole and tower in the power industry. With accumulation of lightning location data, it is found that a fitting value in the empirical formula above varies greatly from an actual monitoring value, so that the actual application effect is influenced. Therefore, targeted statistics on the probability distribution characteristics of lightning current amplitude based on the lightning location data of the high-speed railway can reduce errors caused by using the empirical formula. Overall, obtaining refined ground flash density and cumulative probability function of the lightning current amplitudes along the high-speed railway, and establishing a reasonable calculation model for the lightning outage rate of the contact system will be helpful to reflect the impact of local lightning on the high-speed railway contact system.

### SUMMARY

Aiming at the above problems and defects in the prior art, the present disclosure provides a method for predicting a lightning outage rate of a high-speed railway contact system based on a lightning location. Specifically, accurate calculation of a ground flash density is improved by evaluating detection efficiency and location errors of cloud-to-ground lightning flashes along the high-speed railway, and a cumulative probability function of lightning current amplitudes along the high-speed railway is fitted in a targeted manner, so as to reduce the calculation error of the lightning outage rate of the contact system. The accurate value of the lightning outage rate of the contact system can be applied to the lightning risk assessment, comprehensive lightning protection design and engineering construction fields of high-speed railway lines, providing scientific support for lightning protection and disaster reduction business service and scientific research work.

In order to implement the above objectives, the present disclosure provides a method for predicting a lightning outage rate of a high-speed railway contact system based on a lightning location, including following steps:
setting up a lightning location network by taking a high-speed railway line as a central line, and carrying out a location of the cloud-to-ground lightning flashes through a time of arrival (TOA) method to obtain location errors of the cloud-to-ground lightning flashes;
obtaining a ground flash density along the high-speed railway line according to the location errors of the cloud-to-ground lightning flashes by obtaining a detection efficiency of the cloud-to-ground lightning flashes of the lightning location network, where the ground flash density represents a number of cloud-to-ground lightning flashes detected in a unit area;
obtaining a cumulative probability distribution of the lightning current amplitudes by obtaining cumulative probability values of different lightning current amplitudes based on of the lightning current amplitudes of the cloud-to-ground lightning flashes; and

determining an outage rate of the high-speed railway contact system after lightning strikes according to a lightning outage rate formula of a direct lightning of a messenger wire and contact wire (wire T) of the contact system, a lightning outage rate formula of a direct lightning of an auxiliary feeder (AF) of the contact system and a lightning outage rate formula of an induction lightning of the contact system after obtaining engineering parameters of the contact system of the high-speed railway based on the ground flash density and the cumulative probability distribution of the lightning current amplitudes.

Optionally, in a process of obtaining the location errors of the cloud-to-ground lightning flashes, a plurality of grids symmetrical to each other are arranged at two sides of the line according to the central line, and a time measurement error of a lightning locator for lightning location is obtained;
a plurality of grid points are arranged based on the grids, and three lightning locators closest to each grid point are identified; and
a lightning electromagnetic wave propagation time with errors from each grid point to each station is obtained based on longitude and latitude coordinates of the grid points selected in the grid and longitude and latitude coordinates of the three lightning locators, the location of cloud-to-ground lightning flashes through the TOA method is performed, and a distance from calculation results to the grid points are the location errors of the cloud-to-ground lightning flashes.

Optionally, in a process of selecting the lightning electromagnetic wave propagation time with errors, an error-free propagation time between each grid point and the three lightning locators nearest to each of the grid point is obtained, where the error-free propagation time is expressed as:

$$T = \frac{D}{3.0 \times 1 {0}^{8} ( \text{m/s} )}$$

in the formula, D represents a distance between each grid point and the three lightning locators nearest to each of the grid point;
the lightning electromagnetic wave propagation time with errors is obtained by superposing the error-free propagation time and the time measurement error, where the time measurement error includes distance weighting of a GPS random error, a waveform detection random error and a ground wave propagation effect error.

Optionally, in a process of obtaining the detection efficiency of the cloud-to-ground lightning flashes, the detection efficiency of the cloud-to-ground lightning flashes of the lightning location network corresponding to the grids is generated by obtaining a maximum value of a detection efficiency of cloud-to-ground lightning flashes of any three lightning locator sub-networks in the grid.

Optionally, in a process of obtaining the detection efficiency of the cloud-to-ground lightning flashes of the three lightning locator sub-networks in the grid, the cloud-to-ground lightning flashes detected are expressed as:

$${N}_{1 , 2 , 3} = {N}_{{ε}_{1} {ε}_{2} {ε}_{3}} \\ {N}_{1 , 2} = {N}_{{ε}_{1} {ε}_{2}} \\ {N}_{1 , 3} = {N}_{{ε}_{1} {ε}_{3}} \\ {N}_{2 , 3} = {N}_{{ε}_{2} {ε}_{3}}$$

in the formula, N represents a number of cloud-to-ground lightning flashes actually happened in the grid, ε₁, ε₂, ε₃ represent a detection efficiency of the 1^{st}, 2^{nd} and 3^{rd} lightning locators in the grid, respectively, N_{1,2,3} represents numbers of cloud-to-ground lightning flashes detected by the 3 lightning locators in the grid at the same time, N_{1,2} represents numbers of cloud-to-ground lightning flashes detected by the 1^{st} and 2^{nd} lightning locators in the grid at the same time, N_{1,3} represents numbers of cloud-to-ground lightning flashes detected by the 1^{st} and 3^{rd} lightning locators in the grid at the same time, and N_{2,3} represents numbers of cloud-to-ground lightning flashes detected by the 2^{nd} and 3^{rd} lightning locators in the grid at the same time.

Optionally, in a process of obtaining the detection efficiency of the cloud-to-ground lightning flashes of the lightning location network, the detection efficiency of the grid is expressed as:

$$ε = 1 - {\prod }_{i = 1}^{n} ( 1 - {ε}_{i} ) - {\sum }_{i = 1}^{n} [ {ε}_{i} {\prod }_{j = 1 , j \neq i}^{n} ( 1 - {ε}_{j} ) ] - {\sum }_{i , j = 1 , j \neq i}^{n} [ {ε}_{i} {ε}_{j} {\prod }_{k = 1 , k \neq i , j}^{n} ( 1 - {ε}_{k} ) ]$$

in the formula, i, j and k represent the i^{th}, j^{th} and k^{th} lightning locators, respectively, and n represents the total number of lightning locators in the lightning location network.

Optionally, in a process of obtaining the ground flash density, when a maximum value of the location errors along the high-speed railway line is less than 0.5 km, a circle with a radius of 1 km is drawn; when the maximum value of the location errors along the high-speed railway line is greater than or equals to 0.5 km, a circle with a radius twice the maximum value of the location errors is drawn, a number of cloud-to-ground lightning flashes detected through a location algorithm at 3 stations and above within a range is counted, and then divided by a circle area and a detection efficiency of a grid point, and a ground flash density value of the grid point is obtained,

Optionally, in a process of obtaining the cumulative probability distribution of the lightning current amplitudes, a cumulative probability function of the lightning current amplitudes are fitted according to the cumulative probability values by adopting an expression recommended by an IEEE working group, and a cumulative probability curve of the lightning current amplitudes along the high-speed railway line is then drawn, thereby obtaining the cumulative probability distribution of the lightning current amplitudes, where the cumulative probability function of the lightning current amplitudes is expressed as:

$$P ( I ) = \frac{1}{1 + {( \frac{I}{a} )}^{b}}$$

in the formula, I represents a lightning current amplitude, P(I) represents a probability greater than the lightning current amplitude, and a and b represent fitting parameters.

Optionally, in a process of obtaining the outage rate, the outage rate is expressed as:

$$P = {P}_{directT} + {P}_{directF} + {P}_{i n direct}$$

in the formula, P_{directT} represents a lightning outage rate of direct lightning of the wire T of the contact system, P_{directF} represents a lightning outage rate of direct lightning of the AF of the contact system, and P_{indirect} represents a lightning outage rate of induction lightning of the contact system.

Optionally, a predicting system for implementing the predicting method above, including:
an error calculation module is configured to set up a lightning location network by taking a high-speed railway line as a central line, and carry out the location of cloud-to-ground lightning flashes through the TOA method to obtain location errors of the cloud-to-ground lightning flashes;
a ground flash density calculation module is configured to obtain a ground flash density along the high-speed railway line according to the location errors of the cloud-to-ground lightning flashes by obtaining the detection efficiency of the cloud-to-ground lightning flashes of the lightning location network, where the ground flash density represents the number of cloud-to-ground lightning flashes detected in a unit area;
a calculation module for cumulative probability distribution of the lightning current amplitudes is configured to obtain cumulative probability distribution of the lightning current amplitudes by obtaining cumulative probability values of different lightning current amplitudes based on of the lightning current amplitudes of the cloud-to-ground lightning flashes; and

an outage rate of the high-speed railway contact system after lightning strikes according to the lightning outage rate formula of the direct lightning of the wire T of the contact system, the lightning outage rate formula of the direct lightning of the AF of the contact system and the lightning outage rate formula of the induction lightning of the contact system after obtaining engineering parameters of the contact system of the high-speed railway based on the ground flash density and the cumulative probability distribution of the lightning current amplitudes.

The present disclosure has the following technical effects:
(1) Through the method provided in the present disclosure, the ground flash density and the of the lightning current amplitudes of each statistical grid along the high-speed railway line can be used for representing in detail the regional lightning activity characteristics along with geographical and climate changes, and can reflect the impact of regional lightning strikes differences on the lightning outage rate of the high-speed railway contact system, thereby solving the defect that the lightning outage rate is excessively averaged caused by the use of calculation results on thunderstorm days.
(2) The method provided in the present disclosure gives a comprehensive consideration to the detection efficiency and location errors of the cloud-to-ground lightning flashes along high-speed railway line, and the calculation formula of the lightning outage rate is corrected based on accurate lightning monitoring data, so that the risk of the lightning outage rate of the high-speed railway contact system is reflected in a refined manner, and the differential lightning protection requirements for the high-speed railway contact system can be facilitated.

### BRIEF DESCRIPTION OF THE DRAWING

In order to explain the technical solutions in embodiments of the present disclosure or in the prior art more clearly, the accompanying drawing required in the embodiments is described below briefly. Apparently, the accompanying drawings in the following description show merely some embodiments of the present disclosure, and other drawings is capable of being derived from these accompanying drawings by those of ordinary skill in the art without creative efforts.

FIG. 1 is a flow chart for predicting the lightning outage rate of a high-speed railway contact system based on a lightning location according to the present disclosure.

### DETAILED DESCRIPTION OF THE EMBODIMENTS

In order to make the objectives, technical solutions, and advantages of the embodiments of the present disclosure clearer, the technical solutions of the embodiments of the present disclosure will be described clearly and completely with reference to the accompanying drawings of the embodiments of the present disclosure. Apparently, the described embodiments are some, but not all, embodiments of the present disclosure. Components of the embodiments of the present disclosure, as generally described and illustrated in the accompanying drawings herein, may be arranged and designed in a wide variety of different configurations Therefore, the following detailed description of the embodiments of the present disclosure, as represented in the accompanying drawings, is not intended to limit the scope of the embodiments of the present disclosure, as claimed, but is merely representative of exemplary embodiments of the present disclosure. On the basis of the embodiments of the present disclosure, all other embodiments obtained by a person of ordinary skill in the art without making creative efforts shall fall within the scope of protection of the present disclosure.

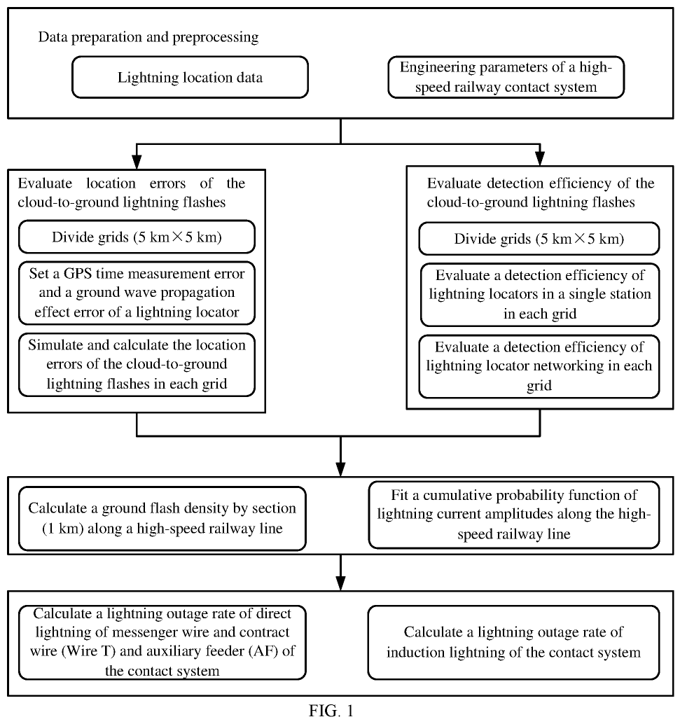

As shown in FIG. 1, the present disclosure provides a method for predicting a lightning outage rate of a high-speed railway contact system based on a lightning location. A refined ground flash density is obtained by calculating a grid difference between detection efficiency and location errors of the cloud-to-ground lightning flashes along a high-speed railway line, a calculation formula of the lightning outage rate is further corrected, and differentiated distribution characteristics of the lightning outage rate of a high-speed railway contact system are obtained by combining the cumulative probability distribution of the lightning current amplitude along the high-speed railway line. The method includes the following specific steps:
step (1), evaluating location errors of the cloud-to-ground lightning flashes along the high-speed railway line;
step (2), evaluating a detection efficiency of the cloud-to-ground lightning flashes along the high-speed railway line;
step (3), calculating a ground flash density along the high-speed railway line;
step (4), fitting a cumulative probability function of lightning current amplitudes along the high-speed railway line; and
step (5), constructing a calculation model for the lightning outage rate of the high-speed railway contact system.

Specific implementation is as follows:

The step (1): evaluating location errors of the cloud-to-ground lightning flashes along the high-speed railway line:

A location algorithm of a lightning locator is mostly time of arrival (TOA) method or is combined with the TOA method, and location errors of the TOA methods mainly come from the accuracy of the time difference Δt of measured lightning waves arriving at different sites, therefore, the higher the accuracy of Δt is, the smaller the location errors become, and vice versa. On the one hand, the GPS time measurement precision of the lightning locator can influence the precision of Δt, electromagnetic waves are sometimes distorted in the propagation process, and there is also a random error, therefore, the GPS random error and the waveform detection random error are set to be 0.1 μs; on the other hand, when propagating on the ground, long waves do not propagate at a speed of light due to the influence of the terrain according to the electromagnetic wave propagation theory, and a time measurement error is thus caused, therefore, a ground wave propagation effect error is set to be about 0.36 μs/100 km according to statistical results.
(1) A high-speed railway line is taken as a central line, 5 km×5 km grids along the central line are divided along the central line, with 2.5 km on the left and right sides of the line respectively, 50 grid points are randomly selected in each grid, 3 lightning locators closest to each grid point are identified, and longitude and latitude coordinates are converted into rectangular coordinates;
(2) a distance D between each grid point and the three lightning locators nearest to each of the grid point is calculated, and the error-free propagation time T is calculated according to the following formula:

$$T = \frac{D}{3.0 \times 1 {0}^{8} ( m / s )}$$

(3) T is added to a time measurement error to obtain a simulation time Tₘ from each grid point to the three lightning locators, where the time measurement errors include a distance weighting of a GPS error of the lightning locators (0.1 μs), a waveform detection random error, and a ground wave propagation effect error;
(4) the time difference required by the TOA method is obtained through the Tₘ, and the location of occurrence of the cloud-to-ground lightning flash is further calculated according to a 3-station location algorithm; and
(5) the distance between the position of each grid point and the result calculated and obtained in the step (4) is determined as the location errors of the cloud-to-ground lightning flashes, and the location errors of each grid by averaging the calculated location errors of 50 grid points in each grid are obtained, and the location errors of the cloud-to-ground lightning flashes of each 5 km×5 km grid along the high-speed railway line is calculated and determined according to the method.

The step (2): evaluating a detection efficiency of the cloud-to-ground lightning flashes along the high-speed railway line:
a high-speed railway line is taken as the central line, 5 km×5 km grids along the central line are divided, and more than 20 times of cloud-to-ground lightning flash are obtained by locating 3 stations or above in each grid, so as to improve the reliability of the lightning detection efficiency. The detection efficiency of each lightning locator in each grid is calculated first, and the detection efficiency of the whole lightning location network in each grid is calculated. Specific steps are as follows:
(1) a lightning location network containing n lightning locators is divided into a plurality of sub-networks consisting of 3 stations, and as for each 3-station sub-network, there will be:

$${N}_{1 , 2 , 3} = {N}_{{ε}_{1} {ε}_{2} {ε}_{3}}$$

$${N}_{1 , 2} = {N}_{{ε}_{1} {ε}_{2}}$$

$${N}_{1 , 3} = {N}_{{ε}_{1} {ε}_{3}}$$

$${N}_{2 , 3} = {N}_{{ε}_{2} {ε}_{3}} ,$$

where N represents the number of cloud-to-ground lightning flashes actually happened in the grid, ε₁, ε₂, ε₃ represent the detection efficiency of the 1^{st}, 2^{nd} and 3^{rd} lightning locators in the grid, respectively, N_{1,2,3} represents numbers of cloud-to-ground lightning flashes detected by the 3 lightning locators in the grid at the same time, N_{1,2} represents numbers of cloud-to-ground lightning flashes detected by the 1^{st} and 2^{nd} lightning locators in the grid at the same time, N_{1,3} represents numbers of cloud-to-ground lightning flashes detected by the 1^{st} and 3^{rd} lightning locators in the grid at the same time, and N_{2,3} represents numbers of cloud-to-ground lightning flashes detected by the 2^{nd} and 3^{rd} lightning locators in the grid at the same time. Thus:

$${ε}_{1} = {N}_{1 , 2 , 3} / {N}_{2 , 3}$$

$${ε}_{2} = {N}_{1 , 2 , 3} / {N}_{1 , 3}$$

$${ε}_{3} = {N}_{1 , 2 , 3} / {N}_{1 , 2} ;$$

(2) the detection efficiency of the same lightning locator in the same grid may be different due to different 3-station sub-networks. When calculating the detection efficiency of a single lightning locator in the evaluated grid, the maximum value of the detection efficiency of cloud-to-ground lightning flashes in the grid after any two lightning locators are selected for networking. The detection efficiency of lightning locators in a single station in the evaluated grid is then calculated and determined.
(3) after a lightning location network containing n lightning locators forms the plurality of 3-station sub-networks, the detection efficiency of each 3-station sub-network in the evaluated grid is calculated according to the following formula:

$$ε = 1 - {\prod }_{i = 1}^{n} ( 1 - {ε}_{i} ) - {\sum }_{i = 1}^{n} [ {ε}_{i} {\prod }_{j = 1 , j \neq i}^{n} ( 1 - {ε}_{j} ) ] - {\sum }_{i , j = 1 , j \neq i}^{n} [ {ε}_{i} {ε}_{j} {\prod }_{k = 1 , k \neq i , j}^{n} ( 1 - {ε}_{k} ) ] ,$$

in the formula, the first item represents 100% detection efficiency, the second item represents the probability that none of the lightning locator detects the cloud-to-ground lightning flash, the third item represents the probability that only one lightning locator detects the cloud-to-ground lightning flash, and the fourth item represents the probability that only two lightning locators detect the cloud-to-ground lightning flash.

The maximum value εₘₐₓ is taken from ε in each evaluated grid to obtain the detection efficiency of cloud-to-ground lightning flashes in the 5 km×5 km grid along the high-speed railway line.

The step (3): calculating a ground flash density along the high-speed railway line:

the ground flash density refers to the number of cloud-to-ground lightning flashes actually occurred in each square kilometer per year, in times/(km²·a). The high-speed railway is divided into a plurality of points along the line at intervals of 1 km, and the ground flash density of each point is calculated as follows: the point is taken as the center of a circle, a circle with twice the maximum value of the location error along the high-speed railway as a radius is drawn, the number of cloud-to-ground lightning flashes at 3 stations and above within the range is counted, and then divided by the circle area and the detection efficiency of the point, and a ground flash density value of the point is thus obtained, which represents the occurrence of cloud-to-ground lightning flashes within the range of 0.5 km around the point. When the maximum value of the location errors along the high-speed railway line is less than 0.5 km, a circle with a radius of 1 km will be drawn. For example: when the maximum value of the location errors along a certain high-speed railway line is 0.8 km, the calculation range of the ground flash density of each point is a circle with the point as the center and a radius of 1.6 km; when the maximum value of the location errors along a certain high-speed rail is 0.4 km, the calculation range of the ground flash density of each point is a circle with the point as the center and a radius of 1 km.

The step (4): fitting a cumulative probability function of the lightning current amplitudes along the high-speed railway line:
lightning current amplitude values of the cloud-to-ground lightning flashes in a width range of 5 km along the high-speed railway line are collected, the percentage of the number of cloud-to-ground lightning flashes with the of the lightning current amplitudes greater than 2, 3, 4, 5, . . . , 199, 200 kA to the total number of cloud-to-ground lightning flashes, respectively, cumulative probability values of different lightning current amplitudes are then obtained, the cumulative probability function of the lightning current amplitudes are fitted by adopting an expression recommended by an IEEE working group, and a cumulative probability curve of the lightning current amplitudes along the high-speed railway line is then drawn thereby. The cumulative probability function of the lightning current amplitudes is expressed as:

$$P ( I ) = \frac{1}{1 + {( \frac{I}{a} )}^{b}} .$$

The step (5): constructing a calculation model for the lightning outage rate of the high-speed railway contact system:
the lightning outage rate of the high-speed railway contact system can be calculated and determined based on the ground flash density value along the high-speed railway line obtained in the step (3) and the cumulative probability distribution of the lightning current amplitudes obtained in the step (4), as well as according to the formulae for lightning outage rate formulae of direct lightning and induction lightning for messenger wire and contact wire (wire T) and auxiliary feeder (AF) of the contact system as defined in the Guide for Technology of Lightning Protection for Traction Power Supply System of High-speed Railway (TB/T3551-2019), and in combination with the engineering parameters of the high-speed railway contact system. The lightning outage rate of direct lightning formula for the wire T is as follows:

$${P}_{directT} = 0.2 η {N}_{g} {\sum }_{k = 0}^{( 300 - IminT ) / Δ I} [ P ( {I}_{min T} + k Δ I ) - P ( {I}_{min T} + k Δ I + Δ I ) ] {D}_{T} ( {I}_{min T} + k Δ I ) ,$$

in the formula, P_{directT} represents the lightning outage rate of direct lightning of the wire T of the contact system, in times per hundred kilometers per year [times/(100 km·a)];
η represents an arc over rate of an insulator;
N_{g} represents a ground flash density, in times per square kilometer per year [times/km²·a)], calculated and obtained in the step (3);
ΔI represents an interval for dividing the lightning current amplitude, in kilo-ampere (kA), and should be optionally less than or equal to 1 kA;
P(I) represents a cumulative probability distribution function of the lightning current amplitudes, calculated and obtained in the step (4);
I_{minT} represents lightning withstand level of the wire T of the contact system, in kilo-ampere (kA); and
D_{T}(I) represents the lightning-inducing width on one side of wire T of the contact system, in meter (m).

A lightning outage rate formula of direct lightning of the AF of the contact system is as follows:

$${P}_{directF} = 0.2 η {N}_{g} {{{\sum }^{( 300 - IminF ) / Δ I}}_{k = 0}}_{}^{} [ P ( {I}_{min F} + k Δ I ) - P ( {I}_{min F} + k Δ I + Δ I ) ] {D}_{F} ( {I}_{min F} + k Δ I )$$

in the formula, parameters have the same meaning as those in the calculation formula for lightning outage rate of direct lightning of wire T, but parameters with a subscript F represent the AF instead of wire T.

A lightning outage rate formula of induction lightning of the AF of the contact system is as follows:

$${P}_{indirect} = 0.2 η {N}_{g} {{{\sum }^{300 / Δ I}}_{k = 0}}_{}^{} [ P ( k Δ I ) - P ( k Δ I + Δ I ) ] [ S ( k Δ I ) - {D}_{F} ( k Δ I ) - {D}_{T} ( k Δ I ) ]$$

in the formula, parameters that are same as those in the lightning outage rate formula of direct lightning the same meaning as those therein, and the meanings of the remaining parameters are as follows:
P_{indirect} represents the lightning outage rate of induction lightning of the contact system, in times per hundred kilometers per year [times/(100 km·a)];
S(I) represents the furthest lightning strikes distance of the insulated flashover caused by induced overvoltage, in meter (m).

The sum of the lightning outage rate of the contact system is:

$$P = {P}_{directT} + {P}_{directF} + {P}_{indirect}$$

For the method predicting the lightning outage rate of a high-speed railway contact system based on a lightning location provided in the present disclosure, accurate calculation of a ground flash density is improved by evaluating detection efficiency and location errors of the cloud-to-ground lightning flashes along the high-speed railway, and the cumulative probability function of the lightning current amplitudes along the high-speed railway is fitted in a targeted manner, so that calculation error of the lightning outage rate of the contact system is reduced, the impact of the regional lightning difference on the lightning outage rate of the high-speed railway contact system can be truly reflected, and the differential lightning protection requirements for the high-speed railway contact system can be facilitated.

The present disclosure is described with reference to flowcharts and/or block diagrams of methods, devices (systems), and computer program products according to the examples of the present disclosure. It should be understood that each flow and/or block in the flow diagrams and/or block diagrams and combinations of the flows and/or blocks in the flowcharts and/or block diagrams may be implemented by computer program instructions. These computer program instructions may be provided for a processor of a general-purpose computer, a special-purpose computer, an embedded processor, or other programmable data processing devices to produce a machine, such that instructions executed by the processor of the computer or other programmable data processing devices produce an apparatus used for implementing functions specified in one or more flows of the flowcharts and/or one or more blocks of the block diagrams.

In the description of the present disclosure, it should be understood that the terms “first” and “second” are for descriptive purposes only and are not to be construed as indicating or implying their relative importance or implicitly specifying the number of indicated technical features. Thus, a feature defined with “first” and “second” may explicitly or implicitly includes one or more of the features. In the description of the present disclosure, “plurality” means two or more, unless expressly specified otherwise.

Apparently, those skilled in the art may make various modifications and variations to the present disclosure without departing from the spirit and scope of the present disclosure. In such a way, if these modifications and variations of the present disclosure fall within the scope of the claims of the present disclosure and their equivalent technologies, the present disclosure is also intended to include these modifications and variations.

What is claimed is:

1. A method for predicting a lightning outage rate of a high-speed railway contact system based on a lightning location, comprising following steps:
setting up a lightning location network by taking a high-speed railway line as a central line, and carrying out a location of cloud-to-ground lightning flashes through a time of arrival method to obtain location errors of the cloud-to-ground lightning flashes;
obtaining a ground flash density along the high-speed railway line according to the location errors of the cloud-to-ground lightning flashes by obtaining a detection efficiency of the cloud-to-ground lightning flashes of the lightning location network, wherein the ground flash density represents a number of cloud-to-ground lightning flashes detected in a unit area;
obtaining a cumulative probability distribution of lightning current amplitudes by obtaining cumulative probability values of different lightning current amplitudes based on the lightning current amplitudes of the cloud-to-ground lightning flashes; and
determining an outage rate of the high-speed railway contact system after lightning strikes according to a lightning outage rate formula of a direct lightning of a messenger wire and contact wire (wire T) of the contact system, a lightning outage rate formula of a direct lightning of an auxiliary feeder (AF) of the contact system and a lightning outage rate formula of an induction lightning of the contact system after obtaining engineering parameters of the contact system of the high-speed railway based on the ground flash density and the cumulative probability distribution of the lightning current amplitudes.

2. The method for predicting the lightning outage rate of the high-speed railway contact system based on the lightning location according to claim 1, wherein
in a process of obtaining the location errors of the cloud-to-ground lightning flashes, a plurality of grids symmetrical to each other are arranged at two sides of the line according to the central line, and a time measurement error of a lightning locator for lightning location is obtained;
a plurality of grid points are arranged based on the grids, and three lightning locators closest to each grid point are identified; and
a lightning electromagnetic wave propagation time with errors from each grid point to each station is obtained based on longitude and latitude coordinates of the grid points selected in the grid and longitude and latitude coordinates of the three lightning locators, the location of cloud-to-ground lightning flashes through the TOA method is performed, and a distance from calculation results to the grid points are the location errors of the cloud-to-ground lightning flashes.

3. The method for predicting the lightning outage rate of the high-speed railway contact system based on the lightning location according to claim 2, wherein
in a process of selecting the lightning electromagnetic wave propagation time with errors, an error-free propagation time between each grid point and the three lightning locators nearest to each of the grid point is obtained, wherein the error-free propagation time is expressed as:
$$T = \frac{D}{3.0 \times 1 {0}^{8} ( m / s )}$$
in the formula, D represents a distance between each grid point and the three lightning locators nearest to each of the grid point; and
the lightning electromagnetic wave propagation time with errors is obtained by superposing the error-free propagation time and the time measurement error, wherein the time measurement error comprises distance weighting of a GPS random error, a waveform detection random error and a ground wave propagation effect error.

4. The method for predicting the lightning outage rate of the high-speed railway contact system based on the lightning location according to claim 3, wherein
in a process of obtaining the detection efficiency of the cloud-to-ground lightning flashes, the detection efficiency of the cloud-to-ground lightning flashes of the lightning location network corresponding to the grids is generated by obtaining a maximum value of a detection efficiency of cloud-to-ground lightning flashes of any three lightning locator sub-networks in the grid.

5. The method for predicting a lightning outage rate of a high-speed railway contact system based on a lightning location according to claim 4, wherein
in a process of obtaining the detection efficiency of the cloud-to-ground lightning flashes of the three lightning locator sub-networks in the grid, the cloud-to-ground lightning flashes detected are expressed as:
$${N}_{1 , 2 , 3} = {N}_{{ε}_{1} {ε}_{2} {ε}_{3}}$$
$${N}_{1 , 2} = {N}_{{ε}_{1} {ε}_{2}}$$
$${N}_{1 , 3} = {N}_{{ε}_{1} {ε}_{3}}$$
$${N}_{2 , 3} = {N}_{{ε}_{2} {ε}_{3}} ,$$
in the formula, N represents a number of cloud-to-ground lightning flashes actually happened in the grid, ε₁, ε₂, ε₃ represent a detection efficiency of the 1^{st}, 2^{nd} and 3^{rd} lightning locators in the grid, respectively, N1.2.3 represent numbers of cloud-to-ground lightning flashes detected by the 3 lightning locators in the grid at the same time, N_{1,2} represent numbers of cloud-to-ground lightning flashes detected by the 1^{st} and 2^{nd} lightning locators in the grid at the same time, N_{1,3} represent the numbers of cloud-to-ground lightning flashes detected by the 1^{st} and 3^{rd} lightning locators in the grid at the same time, and N_{2,3} represent numbers of cloud-to-ground lightning flashes detected by the 2^{nd} and 3^{rd} lightning locators in the grid at the same time.

6. The method for predicting the lightning outage rate of the high-speed railway contact system based on the lightning location according to claim 5, wherein
in a process of obtaining the detection efficiency of the cloud-to-ground lightning flashes of the lightning location network, the detection efficiency of the grid is expressed as:
$$ε = 1 - {\prod }_{i = 1}^{n} ( 1 - {ε}_{i} ) - {\sum }_{i = 1}^{n} [ {ε}_{i} {\prod }_{j = 1 , j \neq i}^{n} ( 1 - {ε}_{j} ) ] - {\sum }_{i , j = 1 , j \neq i}^{n} [ {ε}_{i} {ε}_{j} {\prod }_{k = 1 , k \neq i , j}^{n} ( 1 - {ε}_{k} ) ]$$
in the formula, i, j and k represent the i^{th}, j^{th} and k^{th}lightning locators, respectively, and n represents a total number of lightning locators in the lightning location network.

7. The method for predicting the lightning outage rate of the high-speed railway contact system based on the lightning location according to claim 6, wherein
in a process of obtaining the ground flash density, when a maximum value of the location errors along the high-speed railway line is less than 0.5 km, a circle with a radius of 1 km is drawn; when the maximum value of the location errors along the high-speed railway line is greater than or equals to 0.5 km, a circle with a radius twice the maximum value of the location errors is drawn, a number of cloud-to-ground lightning flashes detected through a location algorithm at 3 stations and above within a range is counted, and then divided by a circle area and a detection efficiency of a grid point, and a ground flash density value of the grid point is obtained.

8. The method for predicting the lightning outage rate of the high-speed railway contact system based on the lightning location according to claim 7, wherein
in a process of obtaining the cumulative probability distribution of the lightning current amplitudes, a cumulative probability function of the lightning current amplitudes are fitted according to the cumulative probability values, and a cumulative probability curve of the lightning current amplitudes along the high-speed railway line is then drawn, thereby obtaining the cumulative probability distribution of the lightning current amplitudes, wherein the cumulative probability function of the lightning current amplitudes is expressed as:
$$P ( I ) = \frac{1}{1 + {( \frac{I}{a} )}^{b}} ,$$
in the formula, I represents a lightning current amplitude, P(I) represents a probability greater than the lightning current amplitude, and a and b represent fitting parameters.

9. The method for predicting the lightning outage rate of the high-speed railway contact system based on the lightning location according to claim 8, wherein
in a process of obtaining the outage rate, the outage rate is expressed as:
$$P = {P}_{directT} + {P}_{directF} + {P}_{indirect}$$
in the formula, P_{directT} represents a lightning outage rate of direct lightning of wire T of the contact system, P_{directF} represents a lightning outage rate of direct lightning of the AF of the contact system, and P_{indirect} represents a lightning outage rate of induction lightning of the contact system.

10. The method for predicting the lightning outage rate of the high-speed railway contact system based on the lightning location according to claim 9, wherein
a predicting system for implementing the predicting method, comprising:
an error calculation module is configured to set up the lightning location network by taking the high-speed railway line as the central line, and carry out the location of cloud-to-ground lightning flashes through the time of arrival method to obtain location errors of the cloud-to-ground lightning flashes;
a ground flash density calculation module is configured to obtain a ground flash density along the high-speed railway line according to the location errors of the cloud-to-ground lightning flashes by obtaining the detection efficiency of the cloud-to-ground lightning flashes of the lightning location network, wherein the ground flash density represents the number of cloud-to-ground lightning flashes detected in the unit area;
a calculation module for cumulative probability distribution of the lightning current amplitudes is configured to obtain cumulative probability distribution of the lightning current amplitudes by obtaining cumulative probability values of different lightning current amplitudes based on of the lightning current amplitudes of the cloud-to-ground lightning flashes; and
an outage rate prediction module is configured to determine an outage rate of the high-speed railway contact system after lightning strikes according to the lightning outage rate formula of the direct lightning of the wire T of the contact system, the lightning outage rate formula of the direct lightning of the AF of the contact system and the lightning outage rate formula of the induction lightning of the contact system after obtaining engineering parameters of the contact system of the high-speed railway based on the ground flash density and the cumulative probability distribution of the lightning current amplitudes.
